(19) United States
(12) Patent Application Publication
(10) Pub. No.: US 2023/0237161 A1
(43) Pub. Date: Jul. 27, 2023

(54) DETECTION OF AND PROTECTION AGAINST CROSS-SITE SCRIPTING VULNERABILITIES IN WEB APPLICATION CODE

(71) Applicant: Microsoft Technology Licensing, LLC, Redmond, WA (US)

(72) Inventors: Safwan Mahmud KHAN, Woodinville, WA (US); Dvir SHAMAY, Bellevue, WA (US)

(21) Appl. No.: 17/585,324

(22) Filed: Jan. 26, 2022

(51) Int. Cl. G06F 21/57; H04L 9/40

(52) U.S. Cl. CPC G06F 21/577; H04L 63/1416

(57) ABSTRACT

The disclosed technology is generally directed to protection against XSS attacks. In one example of the technology, a framework that is associated with a web application is identified. Static code analysis of code that is associated with the web application is performed. Based on the static code analysis of the code, potential cross-site scripting attack vulnerabilities in the code are identified as follows. Encoding bypass functions of the framework in the code are identified. For each identified encoding bypass function of the framework in the code, whether the encoding bypass function has an input that originates from an unknown source and/or an untrusted source is identified. Responsive to identifying the input, information that is associated with the identified input is provided as an identified potential cross-site scripting attack vulnerability in the code.

### BACKGROUND

Cross-Site Scripting (XSS) is a client-side code injection attack. Typically, the attacker aims to execute malicious scripts in a web browser of the victim by including malicious code in a legitimate web page or web application. The actual attack may then occur when the victim visits the web page or web application that executes the malicious code. The web page or web application may then become a vehicle to deliver the malicious script to the user's browser. Typically, vulnerable vehicles that are commonly used for XSS attacks are forums, message boards, and web pages that allow comments.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to protection against XSS attacks. In some examples, a first framework that is associated with a first web application is identified. In some examples, static code analysis of code that is associated with the first web application is performed. In some examples, based on the static code analysis of the code, potential cross-site scripting attack vulnerabilities in the code are identified as follows. In some examples, encoding bypass functions of the first framework in the code are identified. In some examples, for each identified encoding bypass function of the first framework in the code, whether the encoding bypass function has an input that originates from at least one of an unknown source or an untrusted source is determined. In some examples, upon determining that the code has an encoding bypass function that has an input that originates from at least one of an unknown source or an untrusted source, the input is identified. In some examples, responsive to identifying the input, information that is associated with the identified input is provided as an identified potential cross-site scripting attack vulnerability in the code.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a network-connected system;

FIG. 4 is a block diagram illustrating an example of a system for the detection of XSS vulnerabilities in web application code; and

FIG. 5 is a flow diagram illustrating an example process for the detection of XSS vulnerabilities in web application code, in accordance with aspects of the disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “cloud” or “cloud computing” refers to shared pools of configurable computer system resources and higher-level services over a wide-area network, typically the Internet. “Edge” devices refer to devices that are not themselves part of the cloud, but are devices that serve as an entry point into enterprise or service provider core networks.

Briefly stated, the disclosed technology is generally directed to protection against XSS attacks. In some examples, a first framework that is associated with a first web application is identified. In some examples, static code analysis of code that is associated with the first web application is performed. In some examples, based on the static code analysis of the code, potential cross-site scripting attack vulnerabilities in the code are identified as follows. In some examples, encoding bypass functions of the first framework in the code are identified. In some examples, for each identified encoding bypass function of the first framework in the code, whether the encoding bypass function has an input that originates from at least one of an unknown source or an untrusted source is determined. In some examples, upon determining that the code has an encoding bypass function that has an input that originates from at least one of an unknown source or an untrusted source, the input is identified. In some examples, responsive to identifying the input, information that is associated with the identified input is provided as an identified potential cross-site scripting attack vulnerability in the code.

In some examples, an XSS protection scheme is used to protect web application code from XSS vulnerabilities. In some examples, the scheme disallows the use of any web application development framework that is not included in an approved list of secure web application frameworks. In some examples, the scheme performs scans of web application code, performing static code analysis to detect any XSS vulnerabilities present in the code being scanned. In some examples, the static code analysis is based on a set of rules for web application development frameworks that are used by the code.

As discussed above, in some examples, the scheme disallows the use of any web application development framework that is not included in an approved list of secure web application frameworks. In some examples, for each web application development framework that is allowed, a set of rules is used the by scheme. In some examples, the rules are based on methods that bypass the security features of the framework.

A secure web framework typically has bypass methods that are available to support function requirements. However, such bypass methods may expose XSS vulnerabilities. The set of rules may be based on the manner in which bypass methods are allowed to be used. In some examples, for each web application development framework used by the code, any bypass methods used that originate from a source that is untrusted, or from an unknown source, the bypass method is identified as a potential XSS vulnerability. In some examples, each such identified XSS vulnerability is annotated, tagged, or otherwise flagged in the code in order to draw the developer's attention to a potential XSS vulnerability. In this context, “potential” XSS vulnerabilities include “actual” XSS vulnerabilities. Bypass methods used that originate from an unknown source may initially identified as potential XSS vulnerabilities, but some of these may later be annotated by the developer as trusted.

In some examples, particular heuristics are also used in order to reduce false positives for XSS vulnerabilities. Such heuristics may include not identifying locations in the code that render a date or time or identified as generated by the application or system itself as potential XSS vulnerabilities, because there is no user involvement in these cases. Such heuristics may also include not identifying values of the rendering content that are hardcoded somewhere in the codebase for the code that is being scanned as potential XSS vulnerabilities. By using heuristics to eliminate particular data sources as potential XSS vulnerabilities, false positives in the identification of XSS vulnerabilities may be reduced.

### Illustrative Devices/Operating Environments

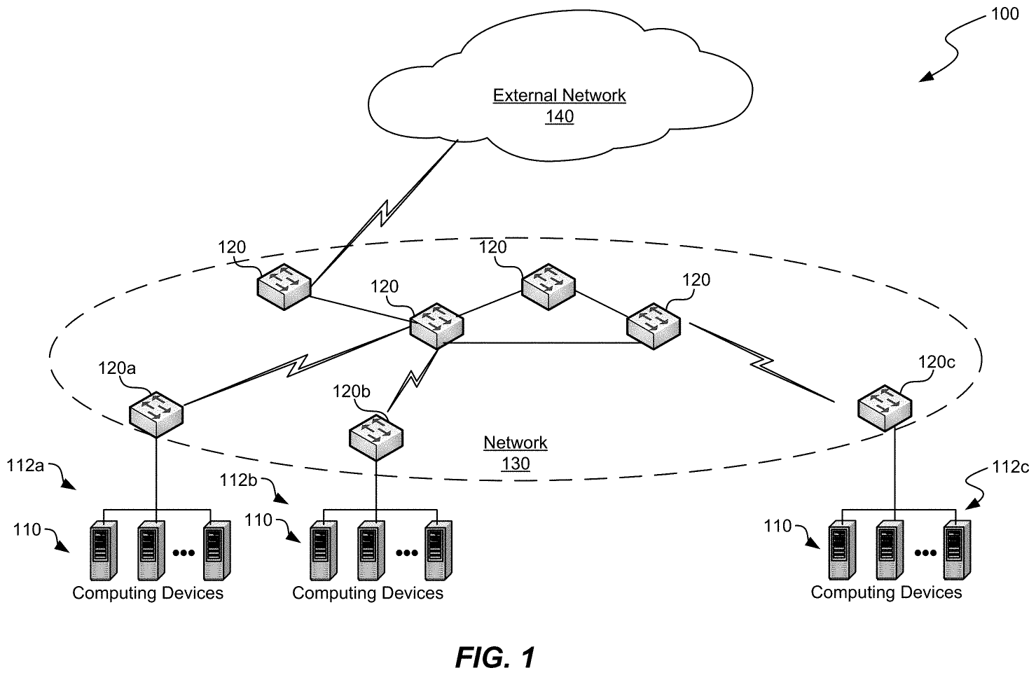

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices no shown in FIG. 1 may be in various locations, including a local computer, on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices no can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices no may be virtually any type of general-or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is a device that is configured to be at least part of a process for the detection of XSS vulnerabilities in web application code.

### Illustrative Computing Device

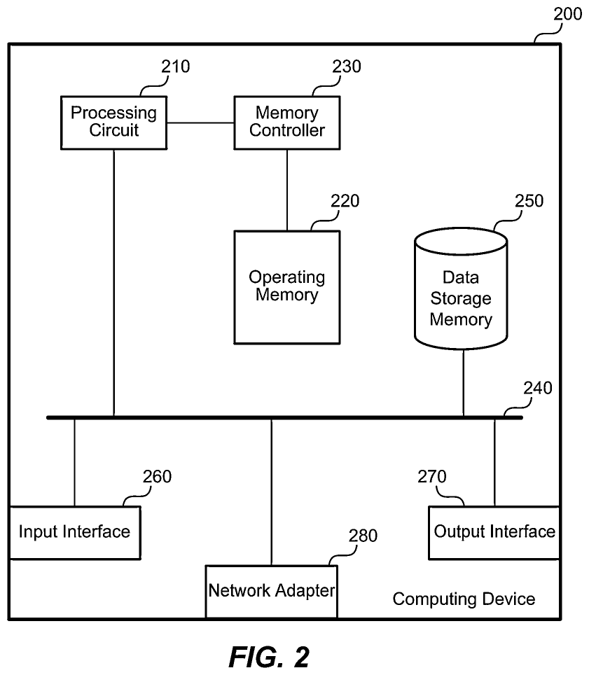

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be a server device such as an application server computer, a virtual computing host computer, or a file server computer, e.g., computing device 200 may be an example of computing device 110 or network node 120 of FIG. 1. Likewise, computer device 200 may be an example any of the devices, a device within any of the distributed systems, illustrated in or referred to in any of the following figures, as discussed in greater detail below. As illustrated in FIG. 2, computing device 200 may include processing circuit 210, operating memory 220, memory controller 230, bus 240, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process. In some examples, other forms of execution may be employed, such as execution directly from data storage component 250, e.g., eXecute In Place (XIP).

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), magnetoresistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although FIG. 2 illustrates bus 240 as a single passive bus, other configurations, such as a collection of buses, a collection of point-to-point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing. In yet another example, input interface 260 and/or output interface 270 may include a universal asynchronous receiver/transmitter (UART), a Serial Peripheral Interface (SPI), Inter-Integrated Circuit (I2C), a General-purpose input/output (GPIO), and/or the like. Moreover, input interface 260 and/or output interface 270 may include or be interfaced to any number or type of peripherals.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 200 is illustrated with certain components configured in a particular arrangement, these components and arrangements are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

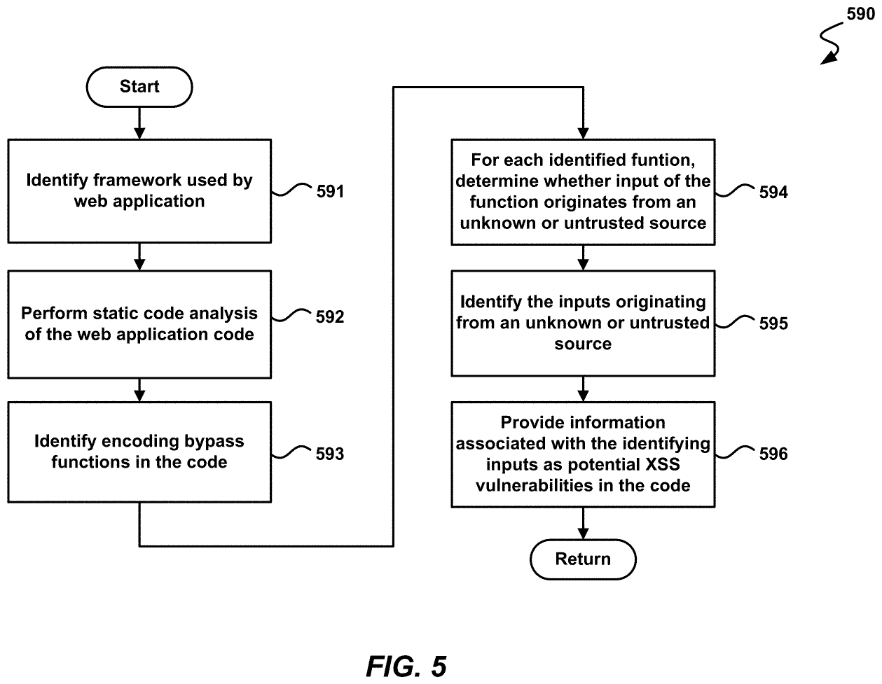

Some examples of computing device 200 include at least one memory (e.g., operating memory 220) having processor-executable code stored therein, and at least one processor (e.g., processing unit 210) that is adapted to execute the processor-executable code, wherein the processor-executable code includes processor-executable instructions that, in response to execution, enables computing device 200 to perform actions, where the actions may include, in some examples, actions for one or more processes described herein, such as the process shown in FIG. 5, as discussed in greater detail below.

### Illustrative Systems

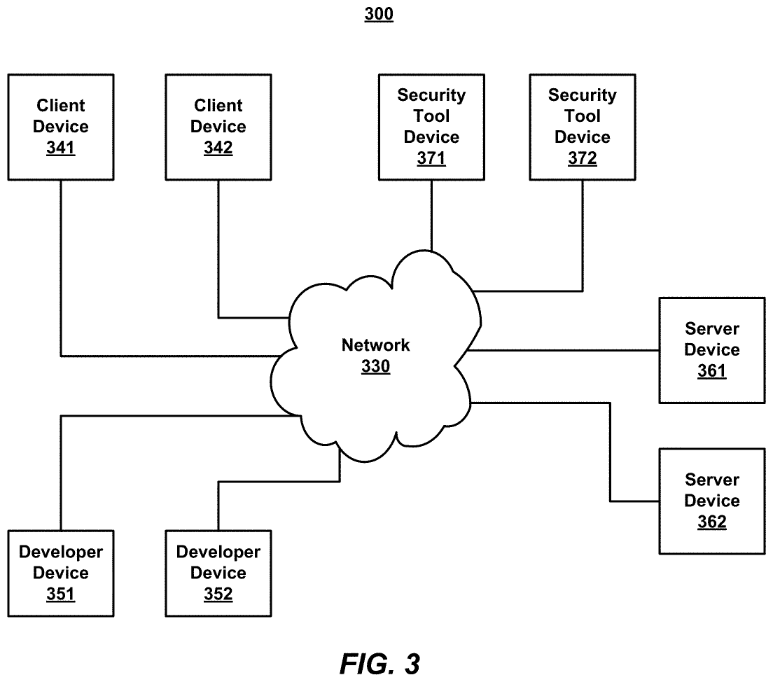

FIG. 3 is a block diagram illustrating an example of a system (300). System 300 may include network 330, as well as client devices 341 and 342; developer devices 351 and 352; server devices 361 and 362; and security tool devices 371 and 372, which, in some examples, all connect to network 330.

Each of client devices 341 and 342; developer devices 351 and 352; server devices 361 and 362; and security tool devices 371 and 372 may include examples of computing device 200 of FIG. 2. FIG. 3 and the corresponding description of FIG. 3 in the specification illustrate an example system for illustrative purposes that does not limit the scope of the disclosure. In some examples, developer devices 351 and 352 are part of one or more distributed systems; server devices 361 and 362 are part of one or more distributed systems; and security tool devices 371 and 372 are part of one or more distributed systems.

In some examples, client devices such as client device 341 and/or client device 342 may execute browsers that may be used by clients to communicate with one or more web pages and/or web applications on server devices, such as server device 361 and/or server device 362 of FIG. 3, via web applications or the like. In some examples, developer devices 351 and 352 may be part of one or more distributed systems that are arranged to develop applications, including web applications. In some examples, server devices 361 and 362 may provide one or more web services on behalf of one or more client devices, such as client devices 341 and 342. In some examples, security tool devices 371 and 372 may be part of one or more distributed systems that are arranged to provide security functions, including scanning code of web applications being developed on developer devices (e.g., developer devices 351 and 352) to identify XSS vulnerabilities in the code.

Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 330 may include various other networks such as one or more networks using local network protocols such as 6LoWPAN, ZigBee, or the like. In essence, network 330 may include any suitable network-based communication method by which information may travel among client devices 341 and 342; developer devices 351 and 352; server devices 361 and 362; and security tools devices 371 and 372. Although each device is shown connected as connected to network 330, that does not necessarily mean that each device communicates with each other device shown. In some examples, some devices shown only communicate with some other devices/services shown via one or more intermediary devices. Also, although network 330 is illustrated as one network, in some examples, network 330 may instead include multiple networks that may or may not be connected with each other, with some of the devices shown communicating with each other through one network of the multiple networks and other of the devices shown instead communicating with each other with a different network of the multiple networks.

System 300 may include more or less devices than illustrated in FIG. 3, which is shown by way of example only.

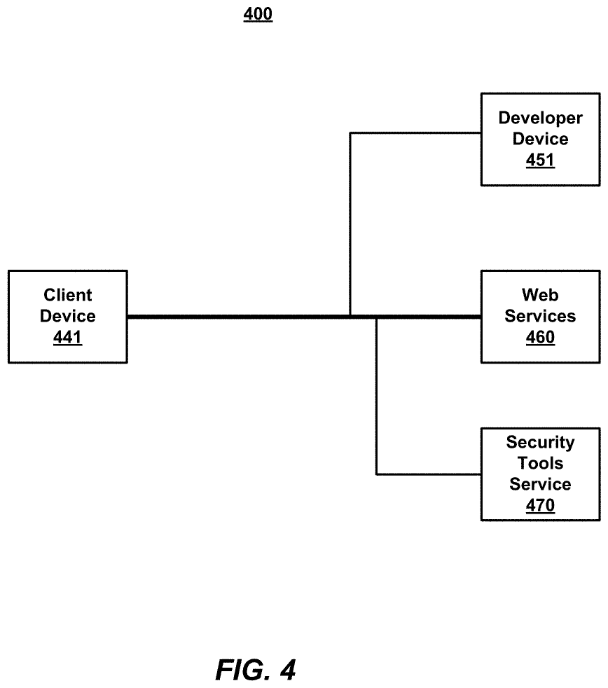

FIG. 4 is a block diagram illustrating an example of a system (400). System 400 may be an example of a portion of system 300 of FIG. 3. System 400 may be a system for the detection of XSS vulnerabilities in web application code. System 400 may include client device 441, developer device 451, web services 460, and security tools service 470. In some examples, security tools service 470 may include one or more devices and/or one or more distributed systems. In some examples, web services 460 may include one or more devices and/or one or more distributed systems.

In some examples, client device 441 may use a web browser to access, in communication with web services 460, one or more web pages and/or one or more web applications. For instance, in some examples, a client may use a browser executing on client device 441 to access a website hosted by web services 460. Various applications, including web applications, may be developed by a developer using developer device 451. After development, the web applications may be used by web service 460. Client device 441 may be vulnerable to XSS attacks, where the attacker aims to execute malicious scripts in a web browser of client device 441 by including malicious code in a legitimate web page or web application. Security tools service 470 may provide one or more security tools, where at least one of the security tools provided by security tools service 470 performs XSS vulnerability detection and protection.

In some examples, web applications developed on developer device 451 may be used by various devices on both the client and server side. Web applications developed on developer device 451 may be scanned for XSS vulnerabilities by security tools service 470. In some examples, if any potential XSS vulnerabilities are identified by security tools service 470, the portion of the code containing the potential vulnerability may be flagged by security tools service 470. In some examples, the flagging is accomplished by security tools service 470 sending developer device 451 a report that identifies the potential XSS vulnerability, including identifying the nature of the potential XSS vulnerability, identifying the code that includes the potential XSS vulnerability, and identifying the exact location of the potential XSS vulnerability in the code.

In some examples, the report may also include instructions for how to deal with the potential XSS vulnerability, including annotation to include in the code to indicate that the input to any bypass function is from a trusted source if applicable, annotation to include in the code to indicate that the code is necessary because of a functional requirement if applicable, and/or the like. In some examples, the report may indicate the file scanned, may include a hyperlink to the location of the potential XSS vulnerability in the code, and may also indicate the branch and commit number for the code that was scanned. If a potential XSS vulnerability is identified by security tools service 470, the developer of the web application may then review the identified potential XSS vulnerability and either fix the issue or identify the issue as a false positive.

If the developer identifies the issue as a false positive, then the developer may use developer device 451 annotate the code in a manner prescribed by security tools service 470. In some examples, the annotation indicates that the code includes a bypass of framework security that is necessary to support functional requirements, indicates that the data is from a trusted source, and specifically identifies the source. In some examples, when security tools service 470 encounters code annotated in this manner, it is treated as coming from a trusted source and is therefore not identified as an XSS vulnerability.

Preferably, even if the bypass of framework security is necessary because of functional requirements, only a bypass from a trusted source should be used. However, in some examples, the scheme may allow the usage even if the source is not entirely trusted, in the case of a functional requirement. In this case, in some examples, the developer may annotate the code, indicating that the bypass is necessary for a functional requirement, and the developer is responsible for any related security risks. In some examples, when such annotation is included, the scheme treats the input as not being untrusted or unknown, even though the input is not entirely trusted.

In some examples, security tools service 470 receives web application code from developer device 451. In some examples, security tools service 470 may use an XSS protection scheme to detect potential XSS vulnerabilities in the received web application code. In some examples, the scheme disallows the code to use of any web application development framework that is not included in an approved list of secure web application frameworks. For instance, in one example, the approved list of secure web applications frameworks is the following: ASP.NET CORE Razor Pages, ASP.NET CORE MVC, ASP.NET MVC, React, AngularJS, and Angular.

In some examples, the list of approved frameworks is updated over time. In some examples, only certain versions of frameworks are allowed, with certain older versions of frameworks on the approved list being disallowed. In various examples, more or less frameworks may be included in the approved list. In some examples, one or more frameworks included in the above example list are not included in the approved list. In some examples, one or more frameworks not included in the above example list are included in the approved list.

In some examples, each of the frameworks in the approved list provides its own built-in mechanism to protect against XSS attacks. In contrast, several frameworks not on the approved list do not encode rendering user input by default (and so have potential XSS vulnerabilities inherently), and/or have other XSS vulnerabilities. By disallowing the use of frameworks that do not have proper built-in XSS vulnerabilities, vulnerability to XSS attack may be reduced. The extent to which frameworks with lesser built-in protection to XSS are allowed on the approved list is typically a trade-off.

For instance, in some examples, frameworks with lesser protections against XSS may be disallowed, combined with more stringent rules for the framework. For instance, in some examples, a framework in which rendering user input is not encoded by default may be allowed, together with a requirement that the application must manually encode user input (e.g., by using a library or in another suitable customized manner) in each possible situation prior to rendering. This trade-off may be handled in different ways in different examples.

Accordingly, in some examples, for each existing web application framework, the framework is included on the approved list if and only if the web application framework uses output escaping to prevent user-controllable data output from being interpreted as activate content, and only fails to use output escaping in specifically defined cases, and only versions of the framework that meet these conditions are included on the approved list. However, in other examples, as discussed above, frameworks for which rendering user input is not encoded by default may be allowed, together with a requirement that the application must manually encode user input.

In any event, for each framework on the approved list, the scheme may include a set of rules that apply with regard to the framework. Accordingly, in some examples, the scheme has framework-specific rules. In some examples, the scheme performs scans of web application code, performing static code analysis to detect any XSS vulnerabilities present in the code being scanned. In some examples, the static code analysis is based on the set of rules for the framework (or for each framework) and its respective version that is used by the code. In some examples, the rules are based on methods that bypass the security features of the framework.

A secure web framework typically has bypass methods that are available to support functional requirements. However, such bypass methods may expose XSS vulnerabilities. The set of rules may be based on the manner in which bypass methods are allowed to be used. In some examples, for each web application development framework used by the code, any bypass methods used that originate from a source that is untrusted, or from an unknown source, the bypass method is identified as a potential XSS vulnerability.

Each framework may have its own built-in XSS protection feature through output escaping. The term “output escaping” may be used to refer to the prevention of user-controllable data outputs from being interpreted as active content, so that the user input is not executed on the user's browser. By using a separate set of rules for each framework, in some examples, XSS vulnerabilities that bypass the output escaping for that framework can be properly identified.

In some examples, particular heuristics are also used in order to reduce false positives for XSS vulnerabilities. Such heuristics may include not identifying locations in the code that render a date or time or an identifier as generated by the application or system itself as potential XSS vulnerabilities, because there is no user involvement or other untrusted source in these cases. Such heuristics may also include not identifying values of the rendering content that is hardcoded somewhere in the codebase that is being scanned as potential XSS vulnerabilities. Not identifying values of the rendering content that is hardcoded somewhere else in the database may include not identifying variable names that may be hardcoded somewhere else in the database as potential XSS vulnerabilities. Such variable names may include, for examples, “path,” “source,” “name,” type,” “model,” or the like. In some examples, this may be accomplished by the use of a list of variables names that may differ from framework to framework. By using heuristics to eliminate particular data sources as potential XSS vulnerabilities, false positives in the identification of XSS vulnerabilities may be reduced. Avoiding false positives may be important for several reasons. Among other things, there is a risk that the developer may turn off or otherwise avoid using XSS detection if the XSS detection has too many false positives.

The identification of XSS vulnerabilities may include static code analysis. In some examples, the static code analysis may be used to identify the flow of user input through the system to understand the security implications of the system design. More specifically, in some examples, the static code analysis may be used to determine whether data can flow from a sensitive data source to an undesired data sink. For instance, for a smartphone, data sources that contain sensitive data may include the phone's unique identifier, SMS messages, etc., and apps that provide services such as banking. Undesired sinks for such data may include network APIs or untrusted applications. In some instances, a data sink may be trusted but with data source being untrusted. The term “data source” may be used to refer as a resource external to an app from which data is read, and the term “data sink” may be used to refer to an external resource to which data is written.

In some examples, the static code analysis uses rules and/or checks, which may begin by identifying rendering places in the code of the application being checked where the content of the code location will be executed by a browser. These places are identified as sinks in some examples. In some examples, a determination is then made, for each of these sinks, as to whether the source of the sink is either untrusted or unknown. In some examples, in order to determine where inputs to bypass functions are coming from, the static code analysis is performed on both client code and server code. As discussed above, the particular heuristics may be used to avoid false positives—as discussed above, based on the heuristics, particular data, such as data which cannot originate from the user, is considered not to be untrusted or unknown for purposes of this determination.

Also, in some examples, location in the code that are annotated in the code as having a trusted source are not identified as untrusted or unknown. An untrusted source may include, for example, the user, an external database, an external API, or the like. In some examples, the user is regarded as untrusted for these purposes because the user may have unknowingly been infected with a malicious script for the purpose of causing an XSS attack.

### Heuristics for Html.Raw( )

As discussed above, each allowed framework may have a different set of rules based on the particular bypasses that exist for that framework. For instance, in .NET framework, Html.Raw( ) is a function for which particular rules may be imposed by the scheme. The Html.Raw( ) function does not escape the input to this function before rendering, which allows any HTML content to be executed by the client's browser that may come from an untrusted source, and therefore, a malicious input may be executed.

Accordingly, in some examples, for code that uses a .NET framework, the static code analysis determines whether the Html.Raw( ) function is used in the code, and if so, identifies each instance of the Html.Raw( ) function that is used. For each instance of the Html.Raw( ) function that is used, in some examples, the scheme attempts to determine the source of the input. If the source of the input is untrusted, or is unknown because the source of the input is not determined, then in some examples, that particular usage of the Html.Raw( ) function is identified as a potential XSS vulnerability.

As discussed above, if the Html.Raw( ) function includes an annotation in a predefined format indicating that the input is from a trusted source and/or that this particular use of the Html.Raw( ) function is a functional requirement, then, in some examples, for purposes of this determination, the input of the Html.Raw( )function is not considered to be from a unknown or an untrusted source, and is thus not identified as a potential XSS vulnerability. The developer is responsible for the accuracy of the annotation and the risk of the vulnerability.

As discussed above, in some examples, heuristics are used for the input of the Html.Raw( ) function to eliminate false positives. For instance, in some examples, when the scheme determines whether the Html.Raw( ) function is related to a system-generated identifier, related to a system-generated date/time, encoded on the client side before rendering, or is hardcoded somewhere in the codebase, then the input of the Html.Raw( ) function is not considered to be from an unknown or an untrusted source, and is thus not identified as a potential XSS vulnerability.

### Heuristics for trustAsHtml( ), trustAsCss( ), trustAsUrl( ), trustAsResourceUrl( ), and trustAsJs( )

In some examples, for code that uses the AngularJS framework, the static code analysis determines whether the code is using any of the following functions: trustAsHtml( ), trustAsCss( ), trustAsUrl( ), trustAsResourceUrl( ), and trustAsJs( ). For each of these functions, the framework does not escape the input to these functions before rendering, which allows any active content to be executed by the browser that may come from an untrusted source, which means that a malicious input maybe executed, creating a potential XSS vulnerability. The active content may include, for example, HTML, JS, CSS, or the like. A set of rules may be set for these functions along similar lines as discussed above for the Html.Raw( ) function in .NET frameworks.

For instance, in some examples, the scheme determines whether any of the above functions is used in the code, and if so, identifies each instance of the function that is used. For each such instance of the function that is used, in some examples, the scheme attempts to determine the source of the input. If the source of the input is untrusted, or is unknown because the source of the input is not determined, then in some examples, that particular usage of the function is identified as a potential XSS vulnerability.

As discussed above, if the function includes an annotation in a predefined format indicating that the input is from a trusted source and/or that this particular use of the function is a functional requirement, then, in some examples, for purposes of this determination, the input of the function is not considered to be from an unknown or an untrusted source, and is thus not identified as a potential XSS vulnerability. The developer is responsible for the accuracy of the annotation and the risk of vulnerability.

As discussed above, in some examples, heuristics are used for the input of the functions to eliminate false positives. For instance, in some examples, when the scheme determines whether the function is related to a system-generated identifier, related to a system-generated date/time, encoded on the client side before rendering, or is hardcoded somewhere in the codebase, then the input of the function is not considered to be from an unknown or an untrusted source, and is thus not identified as a potential XSS vulnerability.

### Heuristics for bypassSecurityTrustHtml( ), bypassSecurityTrustScript( ), bypassSecurityTrustStyle( ), bypassSecurityTrustUrl( ), and bypassSecurityTrustResourceUrl( )

In some examples, for code that uses the Angular framework, the static code analysis determines whether the code is using any of the following functions: bypassSecurityTrustHtml( ), bypassSecurityTrustScript( ), bypassSecurityTrustStyle( ), bypassSecurityTrustUrl( ), and bypassSecurityTrustResourceUrl( ). For each of these functions, the framework does not escape the input to these functions before rendering, which allows any active content to be executed by the browser that may come from an untrusted source, so that a malicious input maybe executed, creating a potential XSS vulnerability. A set of rules may be used for these functions along similar lines as discussed above for the Html.Raw( ) function in .NET frameworks.

For instance, in some examples, the scheme determines whether any of the above functions is used in the code, and if so, identifies each instance of the function that is used. For each such instance of the function that is used, in some examples, the scheme attempts to determine the source of the input. If the source of the input is untrusted, or is unknown because the source of the input is not determined, then in some examples, that particular usage of the function is identified as a potential XSS vulnerability.

As discussed above, if the function includes an annotation in a predefined format indicating that the input is from a trusted source and/or that this particular use of the function is a functional requirement, then, in some examples, for purposes of this determination, the input of the function is not considered to be from an unknown or an untrusted source, and is thus not identified as a potential XSS vulnerability. The developer is responsible for the accuracy of the annotation and the risk of the vulnerability.

As discussed above, in some examples, heuristics are used for the input of the functions to eliminate false positives For instance, in some examples, when the scheme determines whether the function is related to a system-generated identifier, related to a system-generated date/time, encoded on the client side before rendering, or is hardcoded somewhere in the codebase, then the input of the function is not considered to be from an unknown or an untrusted source, and is thus not identified as a potential XSS vulnerability.

### Heuristics for ng-bind-html Directive

In some examples, for code that uses the AngularJS framework or the Angular framework, the static code analysis determines whether the code is using the ng-bind-html directive. Both AngularJS and Angular frameworks provide built-in XSS protection which means they automatically escape all output before rendering on the browser. The ng-bind-html directive partially bypasses this protection by rendering executable content (HTML, JS, CSS) without encoding everything Various bypass exploits are possible. The content to this ng-bind-html may come from an untrusted source, which means that a malicious input may be executed, potentially causing XSS attacks.

A set of rules may be set for the ng-bind-html directive along similar lines as discussed above for certain functions that may bypass security features of a framework. For instance, in some examples, the scheme determines whether the ng-bind-html directive is used in the code, and if so, identifies each instance of the directive that is used. For each such instance of the directive that is used, in some examples, the scheme attempts to determine the source of each of the arguments of the directive. For each argument, if the source of the input is untrusted, or is unknown because the source of the argument is not determined, then in some examples, that particular usage of the ng-bind-html directive is identified as a potential XSS vulnerability.

As discussed above, if the directive includes an annotation in a predefined format indicating that the argument is from a trusted source and/or that this particular use of the directive is a functional requirement, then, in some examples, for purposes of this determination, the argument of the directive is not considered to be from an unknown or an untrusted source, and is thus not identified as a potential XSS vulnerability. The developer is responsible for the accuracy of the annotation and the risk of the vulnerability.

As discussed above, in some examples, heuristics are used for the arguments of the directive to eliminate false positives For instance, in some examples, when the scheme determines whether the argument is related to a system-generated identifier, related to a system-generated date/time, encoded on the client side before rendering, or is hardcoded somewhere in the codebase, then the argument of the directive is not considered to be from an unknown or an untrusted source, and is thus not identified as a potential XSS vulnerability.

### Illustrative Processes

FIG. 5 a diagram illustrating an example dataflow for a process (590) for protection against XSS attacks. In some examples, process 590 may be performed by an example of one or more security tools devices 371 and/or 372 of FIG. 3, by an example of security tools system 470 of FIG. 4, by an example of one or more of device 200 of FIG. 2, or the like.

In the illustrated example, step S91 occurs first. At step S91, in some examples, a first framework that is associated with a first web application is identified. As shown, step S92 occurs next in some examples. At step S92, in some examples, static code analysis of code that is associated with the first web application is performed. As shown, steps S93-596 occur next in some examples. At step S93-596, in some examples, based on the static code analysis of the code, potential cross-site scripting attack vulnerabilities in the code are identified. More specifically, in some examples, steps S93-596 occur as follows.

At step S93, in some examples, encoding bypass functions of the first framework in the code are identified. As shown, step S94 occurs next in some examples. At step S94, in some examples, for each identified encoding bypass function of the first framework in the code, whether the encoding bypass function has an input that originates from at least one of an unknown source or an untrusted source is determined. As shown, step S95 occurs next in some examples.

At step S95, in some examples, upon determining that the code has an encoding bypass function that has an input that originates from at least one of an unknown source or an untrusted source, the input is identified. As shown, step S96 occurs next in some examples. At step S96, in some examples, responsive to identifying the input, information that is associated with the identified input is provided as an identified potential cross-site scripting attack vulnerability in the code. The process may then advance to a return block, where other processing is resumed.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device including at least one memory having processor-executable code stored therein, and at least one processor that is adapted to execute the processor-executable code, wherein the processor-executable code includes processor-executable instructions that, in response to execution, enable the device to perform actions, including:
identifying a first framework that is associated with a first web application;
performing static code analysis of code that is associated with the first web application; and
based on the static code analysis of the code, identifying potential cross-site scripting attack vulnerabilities in the code, the identifying of the potential cross-site scripting attack vulnerabilities including:
identifying encoding bypass functions of the first framework in the code;
for each identified encoding bypass function of the first framework in the code, determining whether the encoding bypass function has an input that originates from at least one of an unknown source or an untrusted source;
upon determining that the code has an encoding bypass function that has an input that originates from at least one of an unknown source or an untrusted source, identifying the input; and
responsive to identifying the input, providing information that is associated with the identified input as an identified potential cross-site scripting attack vulnerability in the code.

2. The apparatus of claim 1, wherein providing the information that is associated with the identified output as the identified potential cross-site scripting attack vulnerability in the code includes providing a report that: specifically identifies the code, identifies a location of the potential cross-site scripting attack vulnerability in the code, and identifies a nature of the identified potential cross-site scripting attack vulnerability in the code.

3. The apparatus of claim 1, the actions further including:
using a set of heuristics to eliminate false positives of cross-scripting attack vulnerabilities;
determining whether the set of heuristics applies to the code; and
upon determining that the set of heuristics applies to the code, not identifying a portion of the code to which the set of heuristics apply as an identified potential cross-scripting attack vulnerability.

4. The apparatus of claim 1, the actions further including:
determining whether the input of the encoding bypass function is related to a system-generated identifier; and
responsive to determining that the input to the encoding bypass function is related to a system-generated identifier, determining that the input does not originate from at least one of an unknown source or an untrusted source.

5. The apparatus of claim 1, the actions further including:
determining whether the input of the encoding bypass function is related to at least one of a system-generated date or a system-generated time; and
responsive to determining that the input to the encoding bypass function is related to at least one of a system-generated date or a system-generated time, determining that the input does not originate from at least one of an unknown source or an untrusted source.

6. The apparatus of claim 1, wherein the code is part of a codebase, the actions further including:
determining whether the input of the encoding bypass function is related to a value that is hardcoded in the codebase; and
responsive to determining that the input to the encoding bypass function is related to a value that is hardcoded in the codebase, determining that the input does not originate from at least one of an unknown source or an untrusted source.

7. The apparatus of claim 1, wherein the code is part of a codebase, the actions further including:
determining whether the encoding bypass function has an accompanying annotation in the code that indicates that the encoding bypass function is included as a functional requirement; and
responsive to determining that the encoding bypass function has the accompanying annotation in the code that indicates that the encoding bypass function is included as a functional requirement, determining that the input does not originate from at least one of an unknown source or an untrusted source.

8. The apparatus of claim 1, the actions further including:
determining which web application frameworks are used by the code;
for each of the determined web applications frameworks that are used by the code, determining whether that web application framework is on an approved list of web applications frameworks; and
if it is determined that the code uses a web application framework that is not on the approved list, disallowing the code from using the web application framework.

9. The apparatus of claim 8, wherein each web application framework on the approved list of web application frameworks is a web application framework that uses output escaping to prevent user-controllable data outputs from being interpreted as active content.

10. A method, comprising:
analyzing code using static code analysis, wherein the code is associated with the first web application; and
via at least one processor, based on the static code analysis of the code, identifying potential cross-site scripting attack vulnerabilities in the code, the identifying of the potential cross-site scripting attack vulnerabilities including:
identifying each function in the code that bypasses output escaping;
for each identified function that bypasses output escaping, determining whether the function has an input that originates from at least one of an unknown source or an untrusted source;
responsive to determining that an identified function that has an input that originates from at least one of an unknown source or an untrusted source, identifying the input; and
upon identifying the input, providing information that is associated with the identified input as an identified potential cross-site scripting attack vulnerability in the code.

11. The method of claim 10, further comprising:
determining whether the input of the identified function is related to a system-generated identifier; and
responsive to determining that the input to the identified function is related to a system-generated identifier, determining that the input does not originate from at least one of an unknown source or an untrusted source.

12. The method of claim 10, further comprising:
determining whether the input of the identified function is related to at least one of a system-generated date or a system-generated time; and
responsive to determining that the input to the identified function is related to at least one of a system-generated date or a system-generated time, determining that the input does not originate from at least one of an unknown source or an untrusted source.

13. The method of claim 10, wherein the code is part of a codebase, the method further comprising:
determining whether the input of the identified function is related to a value that is hardcoded in the codebase; and
responsive to determining that the input to the identified function is related to a value that is hardcoded in the codebase, determining that the input does not originate from at least one of an unknown source or an untrusted source.

14. The method of claim 10, wherein the code is part of a codebase, the method further comprising:
determining whether the identified function has an accompanying annotation in the code that indicates that the identified function is included as a functional requirement; and
responsive to determining that the identified function has the accompanying annotation in the code that indicates that the identified function is included as a functional requirement, determining that the input does not originate from at least one of an unknown source or an untrusted source.

15. The method of claim 10, further comprising:
determining which web application frameworks are used by the code;
for each of the determined web applications frameworks that are used by the code, determining whether that web application framework is on an approved list of web applications frameworks; and
if it is determined that the code uses a web application framework that is not on the approved list, disallowing the code from using the web application framework.

16. A processor-readable storage medium, having stored thereon processor-executable code that, upon execution by at least one processor, enables actions, comprising:
identifying potential cross-site scripting attack vulnerabilities in code, the identifying of the potential cross-site scripting attack vulnerabilities including:
identifying functions in the code that do not prevent inputs of the function from being interpreted as active content;
for each identified function of the code that does not prevent inputs of the function from being interpreted as active content, determining whether the function has an input that originates from at least one of an unknown source or an untrusted source; and
in response to determining that the code has a function that that does not prevent inputs of the function from being interpreted as active content and that has an input that originates from at least one of an unknown source or an untrusted source:
identifying the input; and
providing information that is associated with the identified input as an identified potential cross-site scripting attack vulnerability in the code.

17. The processor-readable storage medium of claim 16, the actions further comprising:
determining whether the input of the identified function is related to a system-generated identifier; and
responsive to determining that the input to the identified function is related to a system-generated identifier, determining that the input does not originate from at least one of an unknown source or an untrusted source.

18. The processor-readable storage medium of claim 16, the actions further comprising:
determining whether the input of the identified function is related to at least one of a system-generated date or a system-generated time; and
responsive to determining that the input to the identified function is related to at least one of a system-generated date or a system-generated time, determining that the input does not originate from at least one of an unknown source or an untrusted source.

19. The processor-readable storage medium of claim 16, wherein the code is part of a codebase, the actions further comprising:
determining whether the input of the identified function is related to a value that is hardcoded in the codebase; and
responsive to determining that the input to the identified function is related to a value that is hardcoded in the codebase, determining that the input does not originate from at least one of an unknown source or an untrusted source.

20. The processor-readable storage medium of claim 16, wherein the code is part of a codebase, the actions further comprising:
determining whether the identified function has an accompanying annotation in the code that indicates that the identified function is included as a functional requirement; and
responsive to determining that the identified function has the accompanying annotation in the code that indicates that the identified function is included as a functional requirement, determining that the input does not originate from at least one of an unknown source or an untrusted source.
